(19) United States
(12) Patent Application Publication
(10) Pub. No.: US 2016/0047330 A1
(43) Pub. Date: Feb. 18, 2016

(54) Device for Controlling Fuel Injection Valve

(71) Applicant: HITACHI AUTOMOTIVE SYSTEMS, LTD., Ibaraki (JP)

(72) Inventors: Osamu MUKAIHARA, Hitachinaka-shi (JP); Masahiro TOYOHARA, Hitachinaka-shi (JP)

(21) Appl. No.: 14/779,092

(22) PCT Filed: Feb. 7, 2014
(86) PCT No.: PCT/JP2014/052825

§ 371 Date: Sep. 22, 2015

(30) Foreign Application Priority Data
Mar. 26, 2013 (JP) 2013-063198

(51) Int. Cl. F02D 41/30

(52) U.S. Cl. CPC F02D 41/30

(57) ABSTRACT

An object of the invention is to reduce an injection quantity of minimum by reducing difference in machines of fuel injection valves and difference in injection quantities of fuel injection valves caused by difference in characteristics. A fuel injection valve drive unit includes a unit that individually sets drive current waveform profiles according to cylinders, and includes a unit that individually sets drive current waveform profiles of the fuel injection valves on the basis of identification information based on injection quantity characteristics of the fuel injection valves.

### TECHNICAL FIELD

The present invention relates to a fuel injection valve control apparatus of a cylinder direct-injection internal combustion engine which directly injects fuel into a cylinder.

### BACKGROUND ART

Conventionally, as a method of driving a fuel injection valve of a direct-injection internal combustion engine, a control of injecting fuel from a fuel injection valve by an injection quantity required from an internal combustion engine on the basis of a drive instruction time (hereinafter, referred to as a pulse width) of a fuel injection valve and a preset drive current waveform profile has been known.

In addition, in a case of an internal combustion engine provided with a plurality of fuel injection valves, a technique of reducing difference in injection timings and injection quantity variation characteristics from each fuel injection valve has been designed. For example, PTL 1 discloses a technique in which change of a drive current value to the time when a needle is opened or a current gradient in the initial stage of current flow is started from a current application start timing, on the basis of information about difference of an injection delay time from the current application start timing to the time when the needle is opened in each fuel injection valve, thereby correcting an injection start time to an injection start time in standard.

Meanwhile, as an indicator representing performance of a fuel injection valve, an injection quantity of static and an injection quantity of minimum are defined. The injection quantity of static is a fuel quantity which the fuel injection valve can inject by holding the fuel injection valve open during a predetermined period (for example, one second), the injection quantity of static is preferably required such that the more injection quantity is secured, and it is possible to cope with the more injection quantity by increasing, as a factor of determining the injection quantity, a needle lift quantity in the fuel injection valve or a designed value of a part represented by an injection caliber provided at the tip of the fuel injection valve.

Meanwhile, the injection quantity of minimum represents the least injection quantity which can be stably injected by any specific fuel and, as requirement, a small injection quantity is preferable. In addition, as the injection quantity which can be stably injected, when the open instruction time for the fuel injection valve is short, the injection quantity may be necessarily reduced, but difference occurs in injection quantities even at the same drive instruction time for each fuel injection valve with the same specification, and thus a condition of the injection quantity is that the injection quantity variation falls within a predetermined range.

In addition, when trying to improve any one of the injection quantity of static and the injection quantity of minimum, the other quantity deteriorates, which is generally in a so-called trade-off relation.

### CITATION LIST

### Patent Literature

PTL 1: JP 4784592 B1

### SUMMARY OF INVENTION

### Technical Problem

However, in an internal combustion engine, from the viewpoint of discharge performance improvement or the like, a so-called multiple injection or the like in which injection is performed plural times within one combustion cycle has been designed. When performing the multiple injection, even in simple calculation, it is necessary to decrease the injection quantity of minimum to a value obtained by dividing a value corresponding to the injection quantity of the time when driving one cycle of the fuel injection valve in the control of the related art by the number of injection times. As a matter of course, in the fuel injection valve oriented to the injection quantity of minimum described above, it is difficult to secure the same injection quantity of static as that of the related art, it is necessary to enlarge an effective area (hereinafter, referred to as a dynamic range) that is a width between the injection quantity of static and the injection quantity of minimum, and thus there is a problem to be improved from the injection quantity characteristics of the related art.

In addition, since a feedback control of increasing or decreasing the fuel injection quantity on the basis of information of an air-fuel ratio sensor installed on an exhaust pipe is general, the fuel injection quantity for a pulse width is preferably linear, but there is a problem that the linearity is not maintained when the injection quantity of minimum is reduced.

In the technique disclosed in PTL 1, injection characteristics other than difference of an injection delay time are not particularly considered, and it is not possible to maintain the linearity of the fuel injection quantity characteristics for the pulse width of the fuel injection valve.

The invention has been made in view of such problems, and an object thereof is to secure linearity of injection quantity characteristics while reducing an injection quantity of minimum by reducing injection quantity variation for each fuel injection valve.

### Solution to Problem

The invention for solving the problems has the following units. Provided are: a fuel injection control unit that performs a current application control of a plurality of fuel injection valves directly injecting fuel for each cylinder into a combustion chamber of an internal engine; an injection quantity characteristic acquiring unit that detects or acquires injection quantity characteristic information of each of the plurality of fuel injection valves from memory medium; and a current waveform profile setting unit that varies a drive current waveform profile of the time when the fuel injection control unit controls current application of the fuel injection valves, and the current waveform profile setting unit individually sets a drive current waveform profile of each fuel injection valve on the basis of the injection quantity characteristic information.

### Advantageous Effects of Invention

According to the invention, a drive waveform optimal for each fuel injection valve can be supplied, the linearity of the fuel injection quantity characteristics for the pulse width, and thus it is possible to reduce the injection quantity of minimum while reducing the injection quantity variation characteristics caused by difference in characteristics or difference in machines present in each fuel injection valve.

### BRIEF DESCRIPTION OF DRAWINGS

FIG. 1 is a diagram illustrating an overall configuration of the invention.

FIG. 2 is a diagram illustrating a configuration of a fuel injection valve control apparatus of a first embodiment.

FIG. 3 is a diagram illustrating a configuration of a fuel injection valve drive unit.

FIG. 4 is a diagram illustrating an example of a drive current waveform profile of the related art.

FIG. 5 is a diagram illustrating an example of injection quantity characteristics of a fuel injection valve.

FIG. 6 is a diagram illustrating an example of a drive current waveform profile of the invention.

FIG. 7 is a diagram illustrating an example of injection quantity characteristics of a fuel injection valve.

FIG. 8 is a diagram illustrating an example of injection quantity characteristics of a fuel injection valve.

FIG. 9 is a diagram illustrating a configuration of a fuel injection valve control apparatus according to a second embodiment.

### DESCRIPTION OF EMBODIMENTS

Hereinafter, embodiments of an internal combustion engine and a fuel injection control apparatus according to the invention will be described.

### First Embodiment

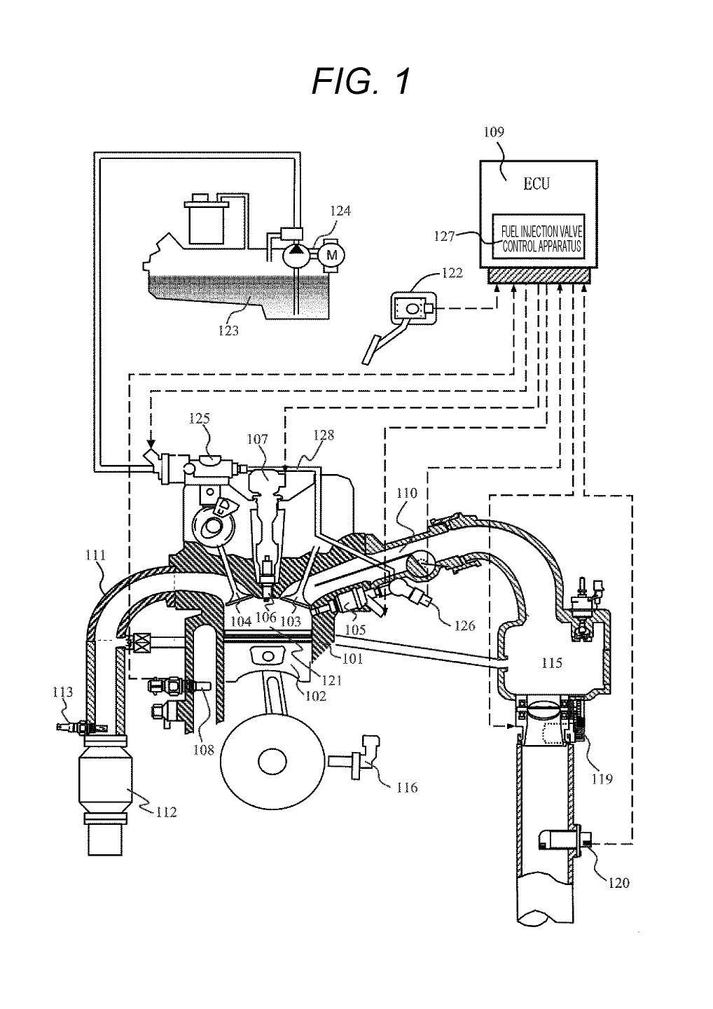

FIG. 1 illustrates a basic configuration of an internal combustion engine and a fuel injection control apparatus thereof according to the invention.

In FIG. 1, the air inhaled into an internal combustion engine 101 passes through an air flow meter (AFM) 120, is inhaled in an order of a throttle plate 119 and a collector 115, and then is supplied to a combustion chamber 121 through an intake pipe 110 and an intake valve 103 provided in each cylinder.

Meanwhile, fuel is sent from a fuel tank 123 to a high pressure fuel pump 125 provided in the internal combustion engine 101 by a low pressure fuel pump 124, and the high pressure fuel pump 125 controls a fuel pressure to be a desired pressure on the basis of a control instruction value from an engine control unit (ECU) 109. The fuel which is thereby at the high pressure is sent to a fuel injection valve 105 through a high pressure fuel pipe 128, and the fuel injection valve 105 injects the fuel to the combustion chamber 121 on the basis of an instruction of a fuel injection valve control apparatus 127 provided in the ECU 109.

The internal combustion engine 101 is provided with a fuel pressure sensor 126 which measures a pressure in the high pressure fuel pipe 128 to control the high pressure fuel pump 125, and it is general that the ECU 109 controls the fuel pressure in the high pressure fuel pipe 128 to be a desired pressure, a so-called feedback control, on the basis of a sensor value thereof. In addition, the internal combustion engine 101 is provided with an ignition coil 107 and an ignition plug 106 for each combustion chamber 121, and the ECU 109 performs a current application control to the ignition coil 107 at a desired timing and an ignition control based on the ignition plug 106.

Accordingly, a mixed gas of the inhaled air and the fuel in the combustion chamber 121 is burned by a spark emitted from the ignition plug 106. An exhaust gas generated by the combustion is discharged to an exhaust pipe 111 through the exhaust valve 104, and a three-way catalyst 112 for purifying the exhaust gas is provided on the exhaust pipe 111. The ECU 109 is provided with the fuel injection control apparatus 127, and receives signals of a crank angle sensor 116 measuring an angle of a crank shaft (not illustrated) of the internal combustion engine 101, the AFM 120 representing an inhaled air quantity, an oxygen sensor 113 detecting an oxygen concentration in the exhaust gas, an accelerator opening sensor 122 representing an opening degree of an accelerator operated by a driver, and a fuel pressure sensor 126.

More specifically, as for the signals input from the sensors, the ECU 109 calculates a requirement torque of the internal combustion engine 101 from the signal of the accelerator opening sensor 122, and determines whether it is an idle state. In addition, a rotation number detection means which calculates a rotation speed (hereinafter, referred to as an engine rotation speed) of the internal combustion engine from a signal of the crank angle sensor 116, and a unit which determines whether the three-way catalyst 112 is in a preheated state from a cooling water temperature of the internal combustion engine 101 obtained from a water temperature sensor 108 and an elapsed time after starting the internal combustion engine are provided.

In addition, the ECU 109 calculates an inhaled air quantity necessary for the internal combustion engine 101 from the requirement torque and the like, and outputs a suitable opening signal to the throttle plate 119, and the fuel injection control apparatus 127 calculates a fuel quantity according to the inhaled air quantity, outputs a fuel injection signal to the fuel injection valve 105, and outputs an ignition signal to the ignition coil 107.

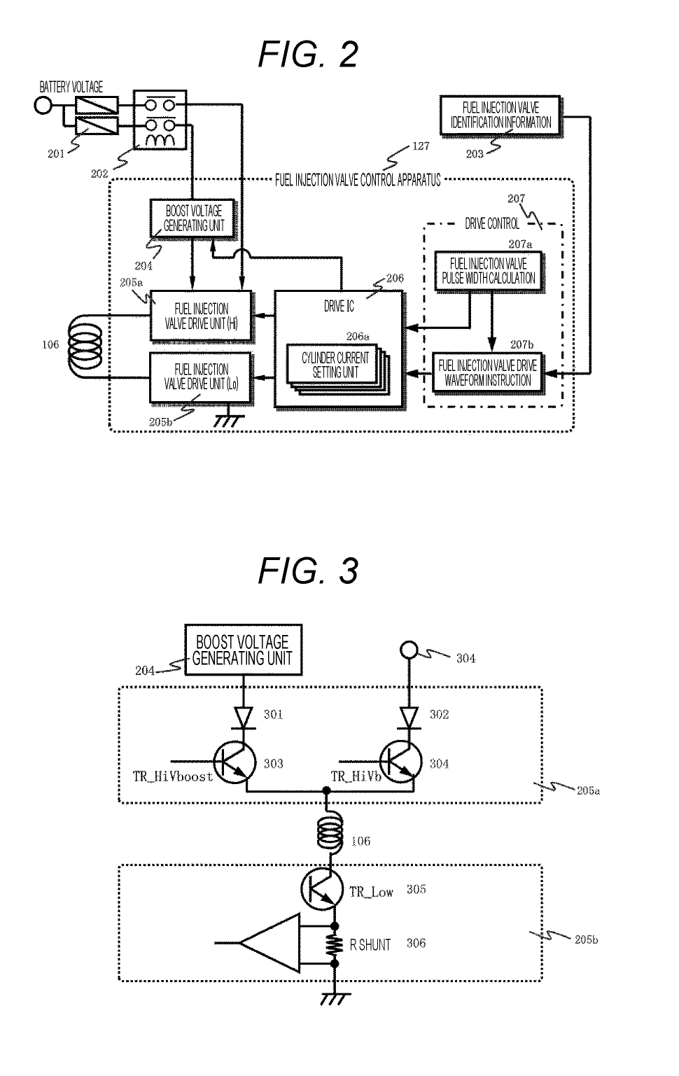

FIG. 2 illustrates an example of a basic configuration of a fuel injection control apparatus according to the invention. In this drawing, a battery voltage supplied from a battery is supplied to the fuel injection valve control apparatus 127 provided in the ECU 109 through a fuse 201 and a relay 202.

Describing a configuration in the fuel injection valve control apparatus 127, a boost voltage generating unit 204 which generates high power source voltage (hereinafter, referred to as a boost voltage) necessary to open the needle provided in the fuel injection valve 106 on the basis of the battery voltage supplied from a battery (not illustrated) is provided, and the boost voltage generating unit 204 raises a voltage to a desired target voltage on the basis of an instruction from a drive IC 206. Accordingly, the power source of the fuel injection valve is provided with two systems of the boost voltage and the battery voltage.

In addition, drive units 205a and 205b are provided on the upstream side and the downstream side of the fuel injection valve 106, a drive current is supplied to the fuel injection valve 106, but details will be described below, and is not described herein.

The boost voltage generating unit 204 and the fuel injection valve drive unit 205a and 205b are controlled by the drive IC 206, and apply a desired drive current to the fuel injection valve 106. In addition, in the drive IC 206, the drive period (current application time of the fuel injection valve 106), the drive voltage value, and the drive current value of the fuel injection valve 106 are controlled on the basis of instruction values calculated by a fuel injection valve pulse width calculation block 207a and a fuel injection valve drive waveform instruction block 207b provided in a block 207 in the ECU 203.

In addition, as characteristics of the invention, a cylinder current setting unit 206a capable of setting a drive current for each cylinder on the basis of the fuel injection valve drive waveform instruction 207b is provided in the drive IC 206. From the related art, a setting unit which sets a drive current on the basis of the fuel injection valve drive waveform instruction 207b is provided in the drive IC. However, since it is assumption that all cylinders are controlled in a common drive waveform, there is a problem that it is difficult to set a drive current optimal for each characteristic of the fuel injection valve 106, but it is possible to thereby set a drive current suitable for each fuel injection valve 106. As described above, the fuel injection quantity and the drive control of the fuel injection valve 106, necessary for combustion of the internal combustion engine 101, are optimally controlled.

In FIG. 3, the drive unit of the fuel injection valve 106 illustrated in FIG. 2 will be described.

As illustrated in FIG. 2, the upstream drive unit 205a of the fuel injection valve 106 supplies power of the boost voltage to the fuel injection valve 106 using a circuit of a TR_Hivboost 303 illustrated in the drawing through a diode 301 provided to prevent current backflow, from the boost voltage generating unit 204 illustrated in the drawing, to supply a current necessary to open the fuel injection valve 106. Meanwhile, after opening the fuel injection valve 106, power of the battery voltage 304 is supplied to the fuel injection valve 106 using a circuit of a TR_Hivb 304 illustrated in the drawing, through a diode 302 for preventing current backflow, like the boost voltage, to apply a current necessary to hold the opening state of the fuel injection valve 106.

Subsequently, the downstream fuel injection valve drive unit 205b of the fuel injection valve 106 is provided with a TR_Low 305, the power supplied from the upstream fuel injection valve drive unit 205a can be applied to the fuel injection valve 106 by turning on the drive circuit TR_Low, and a current value allowed to flow to the fuel injection valve is detected and fed back by detecting the current consumed in the fuel injection valve 106 with a shunt resistor 306, thereby performing a desired current control of the fuel injection valve 106 described below. The above description represents an example of a method of driving the fuel injection valve 106, for example, when a fuel pressure is relatively low, the battery voltage may be used at the time of opening the fuel injection valve 106 instead of the boost voltage.

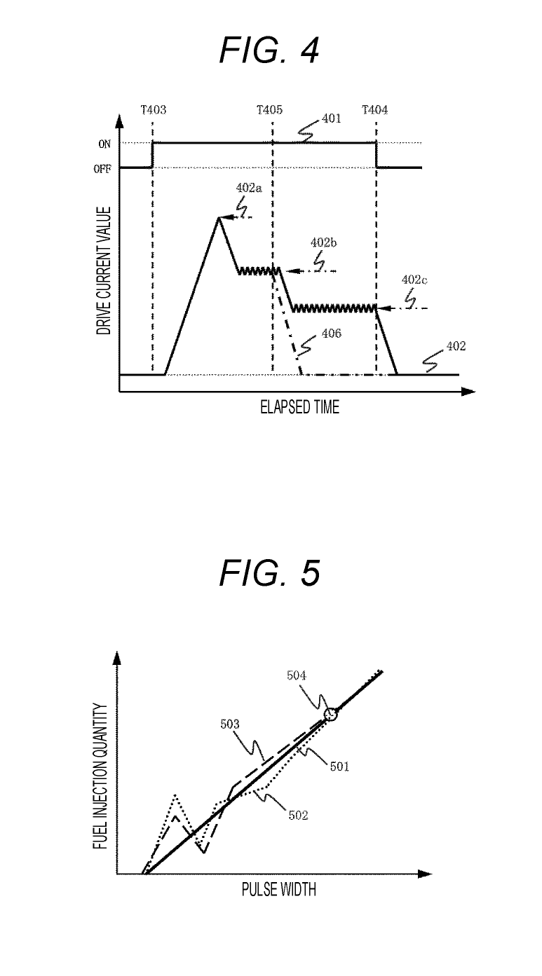

Next, a current control of the fuel injection valve 106 in the related art will be described with reference to FIGS. 4 and 5. Generally, when the fuel injection valve 106 of a direct injection internal engine is driven, a current waveform profile 402 is preset on the basis of characteristics of the fuel injection valve 106, and the injection quantity characteristics of the fuel injection valve 106 based on the current waveform profile 402 are recorded in the ECU 109. The fuel injection valve control apparatus 127 calculates a drive instruction time (hereinafter, referred to as a pulse width) of the fuel injection valve 106 from a drive state (inhaled air quantity) of the internal combustion engine 101 and an injection quantity of the fuel injection valve 106.

FIG. 4 illustrates an example of the control method, and a pulse width 401 is turned on from a desired injection timing T403, and performs a current control of the fuel injection valve 106 on the basis of a preset drive current waveform profile 402.

The drive current waveform profile 402 in the example illustrated in FIG. 4 may be a plurality of target current values such as a valve opening peak current 402a for opening the fuel injection valve 106, and a first holding current 402b and a second holding current 402c for holding the valve opening. For example, the peak current 402a turns on the TR_Hivboost 303 and generates a current value by applying a boost voltage by the boost voltage generating unit 204, and the first holding current 402b turns off the TR_Hivboost 303 and turns on the circuit of TR_Hivb 304 to generate a current value sufficient to open the fuel injection valve 106. The second holding current 402c turns off the TR_Hivboost 303 and turns on the circuit of the TR_Hivb 304 at a duty ratio (a time ratio of on and off) lower than the case of generating the first holding current 402b, and is feedback-controlled to a current value capable of holding the opening of the fuel injection valve 106. The fuel injection valve control apparatus 127 performs an operation of the fuel injection valve 106 by changing each target current value on the basis of a preset control sequence, and continuously applies a drive current to the fuel injection valve 106 to T404 when the pulse width 401 is off.

As described above, the T404 is determined from the drive state (the inhaled air quantity) of the internal combustion engine 101 and the injection quantity characteristics of the fuel injection valve 106. Accordingly, when the requirement injection quantity is increased, the T404 becomes long, and when the requirement injection quantity is small and the pulse width 401 is short, for example, when the drive of the fuel injection valve 106 is stopped at the timing of T405, the current applied to the fuel injection valve 106 is stopped as illustrated by a chain line of 406, and of course, it is not switched to the second holding current 402c.

Next, the injection quantity characteristics of the fuel injection valve 106 will be described with reference to FIG. 5. As described above, the fuel injection quantity is determined from the drive current waveform profile 402 and the pulse width 401, and when the length of the pulse width 401, in other words, the drive time of the fuel injection valve 106 is a horizontal axis and the fuel injection quantity based on each pulse width 401 is a vertical axis, the following characteristics are illustrated in FIG. 5.

Specifically, in FIG. 5, the injection quantity characteristics based on the same drive current waveform profile 402 are represented in the fuel injection valves 106 with the same specification. Herein, the characteristics indicated by a solid line of 501 are ideal, but actually, characteristics of 502 or 503 are represented by difference in machines of the fuel injection valves 106. In addition, as a background in which 501 is ideal, it is general to correct increase or decrease of the fuel injection quantity by an oxygen sensor 113 or an air-fuel ratio sensor (not illustrated). This is for the purpose of correcting an injection quantity error caused by air distribution between cylinders, an operation gap of the fuel injection valves 106 accompanied with change in battery state, a detection error of the fuel pressure sensor 126 or the AFM 120, and deviation of the calculated fuel injection quantity from a real requirement value required in the internal combustion engine in the combustion state or the like of the internal combustion engine 101. In addition, it is ideal that the increase or decrease of the fuel injection quantity accompanied with the correction in this case has linear characteristics with respect to the pulse width 401 since it is easy to correct the fuel injection quantity by making the pulse width 401 long or short.

However, actually, there is difference such as a needle lift quantity in the fuel injection valve or an injection caliber provided at the tip of the fuel injection valve and, as a result, difference is caused to the maximum fuel injection amount for each fuel injection valve 106 with the same specification. For this reason, a spring in the fuel injection valve 106 is adjusted such that the injection quantity for each fuel injection valve 106 falls within a predetermined range at the time point of a specific pulse width of at least one point.

For example, in the fuel injection valve 106 with the injection quantity larger than a reference value, a spring constant of the spring is set to be high and, on the contrary, in the fuel injection valve 106 with injection quantity larger than the reference value, the spring constant of the spring is set to be low.

The injection quantity on a specific pulse width 201 can be managed by this adjustment, but difference occurs in the valve opening timing of the fuel injection valve, and thus difference occurs at the timing when the injection quantity is generated.

In addition, since there is difference in electrical characteristics (resistance value or induction coefficient) among the fuel injection valves 106, there is difference in operation behavior thereof even when the fuel injection valve 106 with eventually the same specification is driven in the same drive current waveform profile 402. For example, for a while from the time point when the injection quantity is injected like 502 and 503, a bouncing is generated in the injection quantity characteristics, and then the bouncing takes a behavior which converges.

In addition, the bouncing is caused by bouncing of the needle when the fuel injection valve 106 is opened and, as the peak current is raised, it is drastically bounced and a period of converging the bouncing is extended.

From such a background, the invention has a characteristic in which the drive current waveform profile 402 can be set for each of the plurality of fuel injection valves 106 provided in the internal combustion engine 101, and the drive current waveform profile suitable for each fuel injection valve 106 can be used on the basis of identification information of each fuel injection valve 106.

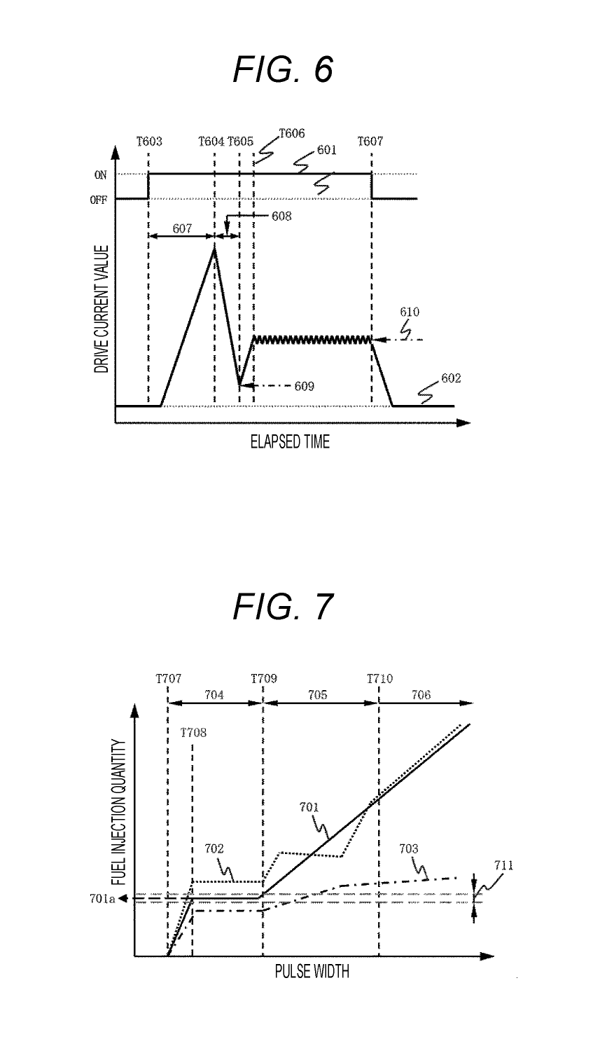

Next, the drive current waveform profile according to the invention will be described with reference to FIGS. 6 and 7.

FIG. 6 illustrates a representative drive current waveform profile in the control apparatus of the invention.

Since a pulse width 601 in FIG. 6 is the same as 401 in FIG. 4, the description is omitted, but the drive current waveform profile 602 has a form different from that of FIG. 4. In addition, like the first holding current 402b and the second holding current 402c illustrated in FIG. 4, the holding current may be generated at the two stages, but the example illustrated in FIG. 6 is an example of a single stage.

First, at a predetermined timing, a period from the time point T603 of starting drive of the fuel injection valve 106 to the first predetermined time is a peak current reaching time 607, and the boost voltage is applied to the fuel injection valve 106 from the boost voltage generating unit 204 at the peak current reaching time.

This may be controlled in the valve opening peak current 402a as an example illustrated in FIG. 4, but an influence based on the driving current difference is significantly large particularly in a low pulse width area where the injection quantity is significantly low and, when the fuel injection valve 106 is controlled by the valve opening peak current 402a, difference occurs in a current detection value necessary for the feedback control unless the difference in machines of the shunt resistor 306 is reduced, and it is difficult to obtain the maximum effect of the invention.

Conversely, in order to obtain the maximum effect of the invention, it is necessary to use the high-precision shunt resistor 306, and thus a problem of increasing costs occurs. Accordingly, in the invention, the problem is solved by time-controlling the drive current waveform profile of each fuel injection valve 106.

Next, the drive current for the fuel injection valve 106 is stopped once from the time point T604 of the peak current reaching time 607 to the second predetermined time as a drive current stop time 608. In addition, as another form, the drive current for the fuel injection valve 106 is stopped once from the peak current reaching time 607 at least to the time of a target stop current 609 set lower than the current value of the peak current reaching time point.

In this case, there is an effect of reducing the bouncing described in the injection quantity characteristics of FIG. 5, but there is small difference in the obtained effect even using any one of the drive current stop time 688 and the target stop current 609 described below in detail. In addition, when there is no problem in the shunt resistor 306 described above, the time point T604 of the peak current reaching time 607 may be a time point of the valve opening peak current 402a.

Thereafter, from the time point of T605 or the time point when the drive current reaches 609 to the time of the valve opening holding current 610 that is a current capable of holding the opening of the fuel injection valve 106, after any one of the boost voltage or the battery voltage is applied to the fuel injection valve 106, and from the time point T606 of the valve opening holding current 610 to the time point T606 of stopping the drive of the fuel injection valve 106, the battery voltage is supplied to the fuel injection valve 106.

FIG. 7 schematically illustrates an example of injection quantity characteristics when the fuel injection valve 106 is controlled using the drive current waveform profile 602 illustrated in FIG. 6.

When the fuel injection valve 106 is driven in the drive current waveform profile 602 illustrated in FIG. 6, a tendency indicated by a solid line of 710 is represented. Specifically, an injection quantity 701a of a specific area 704 is determined on the basis of the peak current reaching time 607 that is the first predetermined time from the time point T603 when the drive of the fuel injection valve 106 is started. Since the drive time of the fuel injection valve 106 is determined in the pulse width 601, a needle lifting quantity of the fuel injection valve is determined by a gradient of the drive current from T603 to T604.

Accordingly, during a period from T603 to T604, the injection quantity according to the drive current of the time point when the pulse width 601 is turned off is represented by a gradient from T707 to T708.

Since the current is not applied to the fuel injection valve 106 from T604 of the peak current reaching time 607 to T605 of the drive current stop time 608, there is no change in the drive current waveform profile even when the pulse width 601 is previously turned off at any timing, and thus the injection quantity from T708 to T709 is substantially a flat tendency. For this reason, in the area of 704, it is possible to obtain the injection quantity depending on the set value of the peak current reaching time 607.

According to the invention, using this, for each fuel injection valve 106, for example, the peak current reaching time 607 when the injection quantity 701a from the fuel injection valve 106 in at least one first predetermined pulse width set in a range of 704 from T708 of the peak current reaching time 607 as a reference set in advance to T709 of the drive current stop time 608 falls within the first predetermined range 711 is measured in advance, and it is considered as one of the fuel injection valve identification information 203.

In addition, specifically describing a method of driving the fuel injection valve 106 in a low pulse width area where the injection quantity described above is significantly low, when it is matched with the injection quantity of 701a in different fuel injection valves 106 with the same specification, it cannot converge into the desired first predetermined range 711 unless a control resolution of the drive current is controlled with precision of 0.1 ms or less at least, although being different according to an absolute value of 701a. Accordingly, in order to realize this, there is also a problem of precision of the shunt resistor 306 which detects the current detection described above, and the invention is to perform the valve opening control of the fuel injection valve 106 in the time control which can be realized in low costs.

It is described that the injection quantity 701a from T708 to T709 is a flat tendency, for example, until T709 on the basis of the drive current stop time 608. However, after the drive current stop time 608, any one of the boost voltage and the battery voltage is applied again to the fuel injection valve 106, the drive current is raised continuously until being the valve opening holding current 610. After being the valve opening holding current 610, the current is applied to the fuel injection valve 106 until the pulse width 601 is turned off by the battery voltage.

The line 701 illustrated in FIG. 7 is linearly raised to be the ideal characteristics described above, but in the case of 702, the bouncing accompanied with the needle behavior described above occurs. The reason is that, when the peak current reaching time 607 according to the invention is not individually set, the drive current waveform profile 602 suitable for the fuel injection valve 106 of 701 applies an excessive current in the fuel injection valve 106 of 702. In addition, in the case of the fuel injection valve 106 having the injection quantity characteristics of 703, on the contrary, the current is short, the opening of the needle is not held, and the injection quantity is not increased even when the pulse width is long.

There may be two reasons as the injection quantity variation characteristics. The first reason is that one of the peak current reaching time 607 and the valve opening peak current 402a is excessively supplied or short, but this can be solved by matching the peak current reaching time 607 for each fuel injection valve 106 described above. The second reason is that the drive current stop time 608 is not suitable for the characteristics of the fuel injection valve 106. This is because, the acceleration of the needle is lowered just before the valve opening using the drive current stop time 608 to reduce the bouncing, but the optimal value is different for each characteristic of the fuel injection valve 106, so that a phenomenon occurs in any fuel injection valve 106 in the same drive current stop time 608. Accordingly, in the invention, during a period from T709 to T710 as an area where the bouncing occurs, at least one second predetermined pulse width is provided and, in the pulse width, the drive current stop time when the injection quantity of the fuel injection valve 106 falls within the second predetermined range is considered as one of the fuel injection valve identification information 203. Accordingly, the injection quantity bouncing from T709 to T710 is reduced, thereby reducing the difference in injection quantities.

Although the description has been made using the drive current stop time 608 to reduce the injection quantity bouncing, there is no clear difference in the effect even using the target stop current 609. Since the absolute value of the injection quantity 701a at the initial stage of the valve opening in the valve opening peak current 402a or the peak current reaching time 607 is low and sensitivity for the peak current is high, the time control is more excellent in controlling than the current control. However, since the absolute value of the injection quantity is high in the injection quantity characteristics in 705 and the influence of the change of the drive current stop time 608 on the injection quantity is not high as the sensitivity of the injection quantity 701a at the initial stage in the peak current reaching time 607, it can be said that clear difference in effect does not occur between the drive current stop time 608 and the target stop current 609.

Next, describing the injection quantity characteristics after T710, the current is set to a drive current that is the minimum current necessary to hold the opening of the fuel injection valve 106 after T710. However, since there is difference in machines for each fuel injection valve 106, it is assumption that the current is the drive current capable of holding the valve opening even for any fuel injection valve 106 with the same specification. In the invention, although the drive current is referred to as the basic drive current, there is a case where a little correction is necessary by the drive current stop time 608 or the set value of the target stop current 609 in the case of the drive current waveform profile 602 illustrated in FIG. 6. For example, when the drive current stop time 608 is long, the drive current of the fuel injection valve 106 is completed too low, and the needle may be a valve closing behavior. Accordingly, it is necessary to correct the target current to be high with respect to the basic drive current. Similarly, when the drive current stop time 608 is short, it is easy to perform the valve opening operation of the needle in characteristics of the fuel injection valve 106. Accordingly, since the injection quantity tends to increase overall, the current is corrected to be lower than the basic drive current to lower the injection quantity after T710, thereby reducing the injection quantity variation.

In the invention, the valve opening holding current 610 including the correction is considered as one of the fuel injection valve identification information 203.

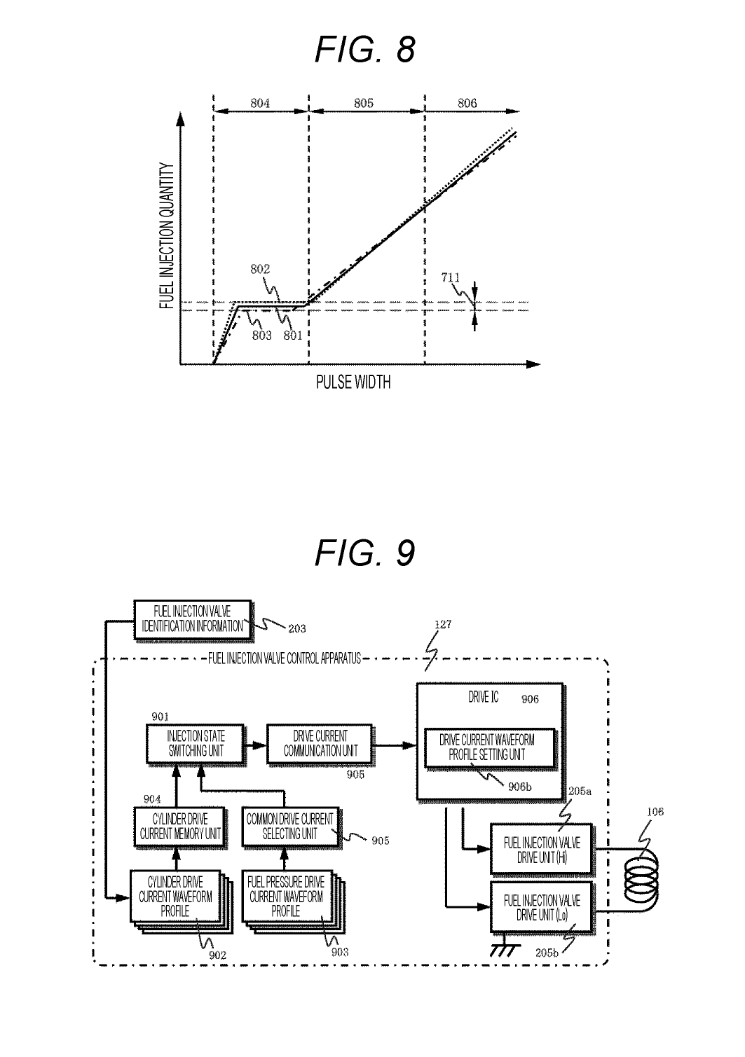

FIG. 8 illustrates injection quantity characteristics when the drive current waveform profile of the fuel injection valves 106 is individually set for each cylinder according to the invention. FIG. 8 illustrates injection quantity characteristics when the drive current waveform profile 602 is the other set value for each fuel injection valve 106 described with reference to FIG. 7 on the basis of the fuel injection valve identification information 203.

First, as for the injection quantity in an area of 804, for example, in the drive current waveform profile 602 illustrated in FIG. 6, the injection quantity characteristics when driving the other fuel injection valve 106 with the same specification as that of the fuel injection valve 106 indicated by a solid line of 701 in FIG. 7 are the form such as 702 or 703. In 701a, even when it deviates from the first predetermined range, it is possible to converge into the first predetermined range 711 by setting the each fuel injection valve 106 and the peak current reaching time 607 to be different values.

Next, as for the injection quantity in an area of 805, the drive current stop time 608 or the target stop current 609 is set to a value suitable for each fuel injection valve 106 to reduce the injection quantity bouncing, and thus an effect of reducing the difference in injection quantities accompanied with the difference in machines is obtained. Moreover, also as for the injection quantity after 806, since the valve opening holding current 610 is corrected for each fuel injection valve 106, it is possible to obtain the effect of reducing the difference in injection quantities thereafter.

It has been known that the injection quantity characteristics illustrated in FIGS. 5, 7, and 8 are changed by the fuel pressure in the high pressure fuel pipe 128 provided with the fuel injection valve 106. Particularly, as for the fuel pressure in a state where the needle is completely opened, the injection quantity is calculated by a fuel pressure correction equation represented by √(actual fuel pressure÷reference fuel pressure), and the invention also includes a unit to correct the drive current waveform profile on the basis of the fuel pressure in the high pressure fuel pipe 128.

For example, at any reference fuel pressure, the drive current waveform profile 602 described from FIGS. 6 to 8 is performed, and the drive current is corrected on the basis of the fuel pressure detected by the fuel pressure sensor 126 during driving the internal combustion engine 101. For example, when the fuel pressure detected by the fuel pressure sensor 126 is higher than the reference fuel pressure, a force that the needle is tightly pressed to the valve closing side becomes strong, it is difficult to perform the valve opening, and thus the drive current waveform profile 601 is optimized by correcting the peak current reaching time 607 to be long. In addition, similarly, the bouncing just after the valve opening is reduced by delay of the valve opening speed of the needle, and thus the drive current stop time 608 may be corrected to be short. On the contrary, as for the valve opening holding current 610, the minimum current value capable of holding the valve opening is raised according to the rising of the fuel pressure, and thus a unit which corrects the valve opening holding current 610 to be high is provided.

On the contrary, when the fuel pressure detected by the fuel pressure sensor 126 is lower than the reference fuel pressure, the force that the needle is tightly pressed to the valve closing side becomes weak, it is easy to perform the valve opening, and thus the drive current waveform profile 601 is optimized by correcting the peak current reaching time 607 to be short. In addition, similarly, the bouncing just after the valve opening is increased by rising of the valve opening speed of the needle, and thus the drive current stop time 608 may be corrected to be long. As for the valve opening holding current 610, the minimum current value capable of holding the valve opening is decreased by lowering of the fuel pressure, and a unit which corrects the valve opening holding current 610 to be low is provided.

By such a control apparatus, particularly, the difference in injection quantities occurring in each fuel injection valve 106 is reduced, thereby reducing the minimum flow rate of the fuel injection valve 106.

In the embodiment of the invention, the specific example of time-controlling the drive current waveform profile 601 on the basis of the fuel injection valve identification information 203 has been described. In the invention, for example, the period from T603 to T604 of supplying the peak current and the period from T604 to T605 of stopping the drive current are time-controlled, and it is possible to perform correction with higher resolution as compared with the case of correcting the drive current waveform profile 601 with the current value such as the target value of the peak current. In addition, parts of the drive current waveform profile for performing the time control are not limited thereto, for example, the period from T403 to T405 illustrated in FIG. 4 may be time-controlled on the basis of the fuel injection valve identification information 203 as a period corresponding to the peak current supply period contributing to the opening of the fuel injection valve 106, and various applications can be realized.

### Second Embodiment

Another embodiment according to the invention will be described with reference to FIGS. 9 and 10. FIG. 9 illustrates an example representing a configuration of a fuel injection valve control apparatus 127 different from that of the first embodiment according to the invention.

Although the fuel injection valve pulse width calculation block 207a and the boost voltage generating unit 204 which generates the boost voltage necessary when the needle provided in the fuel injection valve 106 is opened, on the basis of the battery voltage supplied from the battery (not illustrated) in FIG. 2, are not illustrated in FIG. 9, these components have the same configurations and functions in FIG. 2, and thus the description thereof will not be repeated for convenience of description.

In FIG. 2, as a greatly different point, the cylinder current setting unit 206a capable of setting the drive current for each cylinder on the basis of the fuel injection valve drive waveform instruction 207b is provided in the drive IC 206, but it is not provided in a drive IC 906 in FIG. 9, and a drive current waveform profile setting unit 906b for setting a common drive current for all the fuel injection valves 106 is provided therein. In this case, as illustrated in FIG. 2 in the first embodiment, since the drive current waveform profile 601 different for each cylinder is not set, it is necessary to change the set value of the drive current waveform profile setting unit 907b in time series when drive applicable to difference in machines or difference in characteristics for each fuel injection valve 106 is performed.

For this reason, in FIG. 9, there are provided the fuel injection valve identification information 203 based on the injection quantity characteristics for each fuel injection valve 106, a cylinder drive current memory unit 902 which stores a plurality of drive current waveform profiles 602 set on the basis of the fuel injection valve identification information 203, a normal injection state of performing a control in at least one fuel pressure drive current waveform profile 903 set for each fuel pressure on the basis of the drive state of the internal combustion engine 101, an injection state switching unit 901 which switches an injection state of the fuel injection valve 106 from a multiple injection state of performing a control in the cylinder drive current waveform profile 902 provided with the drive current waveform profile 602 represented by FIG. 6 for each cylinder mainly using the injection quantity of minimum area, a common drive current selecting unit 905 which selects one from the fuel pressure drive current waveform profile 903 when the injection state switching unit 901 determines the injection state as the normal injection state, and a cylinder drive current selecting unit 904 which selects the cylinder drive current waveform profile 902 on the basis of the fuel injection valve identification information 203 when the injection state switching unit determines the injection state as the multiple injection state.

For example, in a case of four-cylinder internal combustion engine 101 including four combustion chambers 121, four cylinder drive current waveform profiles 902 are provided, and the cylinder drive current selecting unit 904 selects, from them, the drive current waveform profile 602 for each cylinder according to injection order of the fuel injection valve 106. More specifically, the cylinder drive current selecting unit 904 recognizes the fuel injection valve 106 being the next operation state according to injection order set among the cylinders and according to the operation completion timing of the fuel injection valve 106 which is operating at the present time point, and determines the drive current waveform profile 602 for the corresponding fuel injection valve 106.

Similarly, when the fuel pressure drive current waveform profile 903 including, for example, four drive current waveform profiles 402, is provided for each fuel pressure, a unit which selects the drive current waveform profile 402 to be used, on the basis of the fuel pressure of this four, is the common drive current selecting unit 905, and the drive current waveform profiles 402 and 602 for each injection state of the fuel injection valve 106 are selected.

In addition, since the injection state switching unit 901 which selects the normal injection state or the multiple injection state on the basis of the drive state of the internal combustion engine 101 is provided on the upstream side thereof, eventually, one drive current waveform profile 402 and 602 is selected. The selected drive current waveform profile 402 and 602 is transmitted from the drive current communication unit 905 to the drive current waveform profile setting unit 906b in the drive IC 906. Accordingly, the drive IC 906 recognizes the drive current waveform profiles 402 and 602 to be used, and can control the fuel injection valve 106 using the upstream drive unit 205a and the downstream drive unit 205b of the fuel injection valve 106.

When the injection state switching unit 901 determines the injection state as the normal injection state, the timing of transmission from the drive current communication unit 905 to the drive current waveform profile setting unit 906b in the drive IC 906 is the time point when the injection state switching unit 901 determines the injection state as the normal injection state and the time point when the common drive current selecting unit 905 changes the drive current waveform profile 402 to be used, whereas, when the injection state switching unit 901 determines the injection state as the multiple injection state, at the time point when the fuel injection valve 106 which is currently operating completes the injection operation, the drive current waveform profile 602 for the fuel injection valve 106 which performs the next fuel injection is transmitted.

In other words, the fuel injection valve control apparatus 127 illustrated in FIG. 9 selects whether to use the common drive current selecting unit 905 or the cylinder drive current selecting unit 904 on the basis of the result determined by the injection state switching unit 901, and then the common drive current selecting unit 905 or the cylinder drive current selecting unit 904 communicates with the drive IC 906 by the drive current communication unit 905 at the timing of switching the drive current waveform profiles 402 and 602.

Accordingly, it is possible to obtain the same effect as that of the first embodiment by managing, in time series, the drive current waveform profile setting unit 906b, only one of which is provided in the drive IC 906.

### REFERENCE SIGNS LIST

106 fuel injection valve
127 fuel injection valve control apparatus
201 fuse
202 relay
203 fuel injection valve identification information
204 boost voltage generating unit
205a fuel injection valve drive unit (upstream side)
205b fuel injection valve drive unit (downstream side)
206 fuel injection valve drive IC
206a cylinder current setting unit
207 drive control block
207a fuel injection valve pulse width calculation block
207b fuel injection valve drive waveform instruction block

1. A control apparatus for a fuel injection valve comprising:
a fuel injection control unit that performs a current application control of a plurality of fuel injection valves directly injecting fuel for each cylinder into a combustion chamber of an internal engine;
an injection quantity characteristic acquiring unit that detects or acquires injection quantity characteristic information of each of the plurality of fuel injection valves from memory medium; and
a current waveform profile setting unit that varies a current waveform profile of the time when the fuel injection control unit controls current application of the fuel injection valves,
wherein the current waveform profile setting unit individually sets a drive current waveform profile of each fuel injection valve on the basis of the injection quantity characteristic information,
the current waveform profile includes a peak current supply period for opening the fuel injection valve and a holding current supply period for holding the fuel injection valve open by supplying a battery voltage,
the fuel injection control unit supplies, in the peak current supply period, a boost voltage obtained by raising the battery voltage or supplies a voltage to supply a current higher than that of the holding current period, and
the current waveform profile setting unit time-controls the peak current supply period of each fuel injection valve on the basis of the injection quantity characteristic information.

2. The control apparatus for a fuel injection valve according to claim 1, wherein
the current waveform profile includes a peak current supply period for opening the fuel injection valve and a holding current supply period for holding the fuel injection valve open by supplying a battery voltage,
the fuel injection control unit supplies, in the peak current supply period, a boost voltage obtained by raising the batter voltage or supplies a battery voltage of a duty ratio higher than the holding current, and
the current waveform profile setting unit time-controls the peak current supply period of each fuel injection valve on the basis of the injection quantity characteristic information.

3. The control apparatus for a fuel injection valve according to claim 2, further comprising a voltage raising unit that raises the battery voltage to a desired voltage,
wherein the current waveform profile has a drive current stop period between the peak current supply period and the holding current supply period, and stops supplying both of the boost voltage generated by the voltage raising unit and the battery voltage in the drive current stop period.

4. The control apparatus for a fuel injection valve according to claim 3, wherein the fuel injection characteristic information is a length of the peak current supply period when the fuel injection control unit sets a current application time to end a current application control of a specific fuel injection valve either in the peak current supply period or in the drive current stop period, and allows the fuel injection quantity injected from the specific fuel injection valve to fall within a predetermined range.

5. The control apparatus for a fuel injection valve according to claim 3, wherein the fuel injection characteristic information is a length of the drive current stop period when the fuel injection control unit sets a current application time to end a current application control of a specific fuel injection valve in the holding current supply period, and allows the fuel injection quantity injected from the specific fuel injection valve to fall within a predetermined range.

6. The control apparatus according to claim 3, wherein in the drive current stop period, the supply of both of the boost voltage generated by the voltage raising unit and the battery voltage is stopped from any one timing of the time point of the peak current and the time point of a peak current target value in the peak current supply period to the timing of a target stop current set lower than at least one of the current value of the time point of the peak current or the peak current target value.

7. The control apparatus for a fuel injection valve according to claim 3, wherein a target holding current value of the holding current supply period is corrected according to at least one of a length of the drive current stop period and a target stop current decreased in the drive current stop period, and fuel injection valve identification information is the corrected target holding current value.

8. The control apparatus for a fuel injection valve according to claim 3, wherein the current waveform profile allows the drive current of the time when the needle of the fuel injection valve starts valve closing to be a valve closing start current, and the drive current is stopped from the time point when the current application time set by the fuel injection control unit is stopped to the time point when the current value of the holding current supply period coincides with the valve closing start current.

9. The control apparatus for a fuel injection valve according to claim 3, further comprising a drive current waveform profile correcting unit that corrects increase and decrease of the current value of the current waveform profile on the basis of an upstream fuel pressure of the fuel injection valve,
wherein when the fuel pressure detected by a fuel pressure sensor is higher than a reference fuel pressure, the drive current waveform profile correcting unit performs at least one of correcting the peak current supply period to be long, correcting the drive current stop period to be short, and correcting a current value of the holding current supply period to be high.

10. The control apparatus for a fuel injection valve according to claim 3, further comprising a drive current waveform profile correcting unit that corrects increase and decrease of the current value of the current waveform profile on the basis of an upstream fuel pressure of the fuel injection valve,
wherein when the fuel pressure detected by a fuel pressure sensor is lower than a reference fuel pressure, the drive current waveform profile correcting unit performs at least one of correcting the peak current supply period to be short, correcting the drive current stop period to be long, and correcting a current value of the holding current supply period to be low.

11. The control apparatus for a fuel injection valve according to claim 3, further comprising a drive current communication unit that transmits a current waveform profile selected by the current waveform profile setting unit to the fuel injection control unit,
wherein the fuel injection control unit performs a current application control of the fuel injection valve on the basis of information of the current waveform profile received from the drive current communication unit and a drive instruction value about a current application time of the fuel injection valve, and
the drive current communication unit transmits, when performing multiple injection of injecting fuel plural times during one cycle of the internal combustion engine, a current waveform profile for the fuel injection valve performing the next injection whenever each of the plurality of fuel injection valves completes the fuel injection.
